(19) United States
(12) Patent Application Publication
(10) Pub. No.: US 2018/0373653 A1
(43) Pub. Date: Dec. 27, 2018

(54) COMMITMENT OF ACKNOWLEDGED DATA IN RESPONSE TO REQUEST TO COMMIT

(71) Applicant: HEWLETT PACKARD ENTERPRISE DEVELOPMENT LP, Houston, TX (US)

(72) Inventors: Gregory Lee Dykema, Fremont, CA (US); Joel Lach, Fremont, CA (US); Siamak Nazari, Fremont, CA (US); Michael T. Longenbach, Colorado Springs, CO (US)

(21) Appl. No.: 15/629,350

(22) Filed: Jun. 21, 2017

(51) Int. Cl. G06F 13/24; G06F 13/42; G06F 11/07

(52) U.S. Cl. CPC G06F 13/24; G06F 11/0745; G06F 11/0793; G06F 13/4282

(57) ABSTRACT

An example computing resource may include computing circuitry that includes logic. The logic may be executable to receive a series of data and an end of transfer message associated with the series of data. The logic may also be executable to, in response to a determination that the end of transfer message indicates a request for acknowledgment, send an acknowledgment to a sender of the series of data after receipt of all the series of data at the computing circuitry is complete and before the series of data is committed to a memory associated with a processing resource. The memory and the processing resource are separate from the computing circuitry. The logic may also be executable to, in response to a request to commit received data, commit the acknowledged and uncommitted series of data to the memory associated with the processing resource and interrupt the processing resource. The interrupt indicates that the acknowledged series of data is committed to the memory associated with the processing resource.

### BACKGROUND

A computing system with multiple computing devices may transfer data between the computing devices for various reasons. For example, a computing system with multiple computing devices may transfer data between the computing devices for data duplication or data mirroring. In such examples, data mirroring may be performed to assist in providing high availability and reliability for the computing system.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 is a block diagram of an example computing system including computing circuitry to acknowledge a series of data, receive a request to commit data, and commit acknowledged data;

FIG. 2 is a block diagram of an example computing system including computing circuitry to acknowledge a series of data, receive a request to commit data, and commit acknowledged data;

FIG. 3 is a block diagram of an example computing system with multiple instances of computing circuitry to acknowledge and commit a series of data; and

FIG. 4 is a flowchart of an example method of a computing system including acknowledging and committing a series of data.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

As noted above, a computing system with multiple computing devices may transfer data between the computing devices for various reasons. For example, a computing system with multiple computing devices may transfer data between the computing devices for data duplication or data mirroring. In such examples, data mirroring may be performed to assist in providing high availability and reliability for the computing system. Such data transfers may include a request for acknowledgment from the receiving computing device and commitment to a memory accessible by a processor on the receiving computing device. In some examples, acknowledgment is requested for all data transfers and the computing device may send acknowledgment after the data has been committed to memory accessible by the processor. While waiting for such acknowledgement may improve reliability, it may also introduce latency into the data transfer process.

To address these issues, examples described herein may utilize computing circuitry to, upon full receipt of a series of data and an indication in an end of transfer (EOT) message that an acknowledgment is requested, return an acknowledgment to the sender of a series of data, even when the series of data is not yet committed to memory associated with a processing resource. Such examples may provide a quick and efficient method to acknowledge data transfers. Upon receipt of a request to commit data, the computing circuitry may commit the acknowledged and uncommitted series of data to a memory associated with a processing resource followed by an interrupt, the interrupt indicating to the processing resource that the acknowledged series of data has been committed to the memory associated with the processing resource. Such examples may provide the ability to cause the acknowledged data to be committed to the memory associated with the processing resource. Such examples may also limit requests to commit data to when computing device failure occurs, thus limiting commits to certain circumstances and allowing for an efficient computing system.

For example, a computing device may include computing circuitry. The computing circuitry may comprise logic executable to receive a series of data and an end of transfer (EOT) message. The EOT message may be associated with the series of data. The computing circuitry may determine whether the EOT message includes an indication that an acknowledgment is requested. In response to an indication that an acknowledgment is requested, the computing circuitry may send an acknowledgment to the sender of the series of data upon full receipt of the series of data. The computing circuitry may send the acknowledgment before the series of data is committed to a memory associated with a processing resource, the memory and processing resource being separate from the computing circuitry. The computing circuitry may comprise logic executable to receive a request to commit received data. In response to the request to commit data, the computing circuitry may commit any acknowledged and uncommitted data to the memory associated with the processing resource and then commit an interrupt to the memory. The interrupt indicating to the processing resource that the acknowledged series of data is committed to the memory.

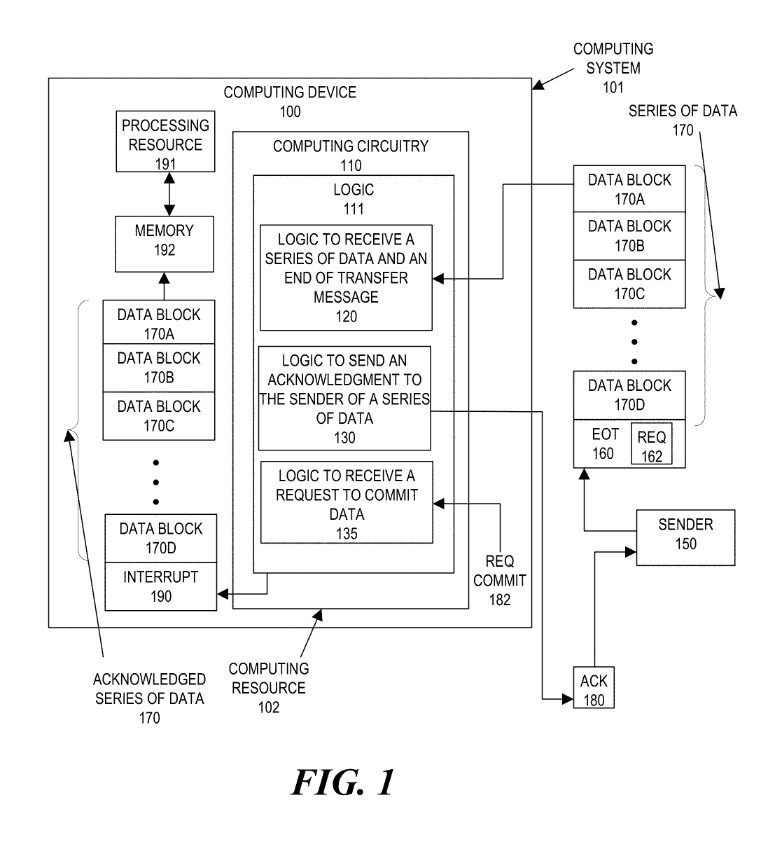

FIG. 1 is a block diagram of an example computing system 101 including computing circuitry 110 to acknowledge a series of data 170. In FIG. 1, the computing system 101 may comprise a computing device 100 including computing circuitry 110, memory 192, and at least one processing resource 191, such as a central processing unit (CPU). The memory 192 in the computing device 100 is associated with the processing resource 191. In FIG. 1, the series of data 170 is shown as a series of data blocks or writes for illustrative purposes. In the example of FIG. 1, data block 170A is a first data block in series of data 170, and is followed by subsequent data blocks 170B, 170C, . . . 170D, series of data 170 may include zero or more data blocks between data blocks 170C and 170D. Although series of data 170 includes four or more data blocks in the example of FIG. 1, in other examples, series of data 170 may include more, fewer, or different data blocks in different examples. In some examples, the sender 150 may be identical to or similarly structured to the computing device 100 and the computing device 100 may send, as well as receive, data to other identical or similarly structured computing devices 100.

As used herein, a “computing device” may be a storage array, storage device, storage enclosure, server, desktop or laptop computer, switch, router, computer cluster, node, partition, virtual machine, or any other device or equipment including a controller, a processing resource, or the like. In examples described herein, a “processing resource” may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution instructions stored on a machine-readable storage medium, or a combination thereof.

In examples described herein, computing circuitry 110 may be any suitable hardware or combination of hardware and programming to send acknowledgments and commit data, as described herein. In some examples, a computing resource 102 may comprise computing circuitry 110. In examples described herein, a computing resource 102 may be a computing device 100 or a resource that may be included as a component of a computing device 100. For example, a computing resource 102 herein may comprise an application-specific integrated circuit (ASIC) that comprises computing circuitry 110. In other examples, the computing resource 102 may comprise a field-programmable gate array (FPGA) implementing computing circuitry 110. In other examples, the computing resource 102 may comprise any other suitable implementation of computing circuitry 110. In some examples, the functionalities described herein in relation to logic 111 may be implemented by one or more engines which may be any combination of hardware and programming to implement the functionalities of the engine(s).

In examples described herein, computing circuitry 110 may execute logic 111 to perform the functionalities described herein in relation to computing circuitry 110. In some examples, the logic 111 may be implemented in hardware (e.g., in circuitry of an ASIC). In such examples, the logic 111 may be executed by the hardware to perform the functionalities described herein in relation to computing circuitry 110. In such examples, computing circuitry 110 may include the logic 111 (e.g., the hardware to implement logic 111).

In other examples, computing circuitry 110 may be implemented in any suitable combination of hardware and programming (e.g., in circuitry of an ASIC). In examples described herein, such combinations of hardware and programming may be implemented in a number of different ways. For example, the programming for computing circuitry 110 may be processor executable instructions stored on at least one non-transitory machine-readable storage medium and the hardware for computing circuitry 110 may include processing resource(s) or other electronic circuitry to execute those instructions. In some examples, the hardware may also include other electronic circuitry to at least partially implement computing circuitry 110. In some examples, the at least one machine-readable storage medium may store instructions that, when executed by the at least one processing resource 191, at least partially implement some or all of logic 111. In such examples, a computing resource 102 implementing computing circuitry 110 may include the at least one machine-readable storage medium storing the instructions and the processing resource(s) or other electronic circuitry to execute the instructions. In some examples, computing circuitry 110 may comprise the hardware to execute logic 111, as described above, while logic 111 is stored separate from but accessible to the hardware of computing circuitry 110.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Any machine-readable storage medium described herein may be non-transitory.

As used herein, “memory associated with a processing resource” may be memory that the processing resource is to utilize as main memory, such as, for example, volatile working memory that the processing resource is to use for data storage and retrieval during execution of instructions stored on and retrieved from the memory for execution. In some examples, the memory associated with the processing resource may be memory that is directly accessible to the processing resource. In some examples, the memory associated with the processing resource may be the volatile memory from which the processing resource directly retrieves and executes instructions of an operating system, program, application, or the like, that is currently being executed by the processing resource. In some examples, the memory associated with the processing resource may be the volatile memory from which any instructions executed by the processing resource are retrieved for execution (after a boot process). For example, the memory may be volatile memory, such as random-access memory (RAM). In some examples, the memory associated with the processing resource may be directly accessible to the processing resource and not directly accessible to any other processing resource. In some examples, the memory associated with the processing resource may be directly coupled to the processing resource and not directly coupled to any other processing resource. In some examples, the memory associated with the processing resource may comprise a cache on a CPU die on which the processing resource is implemented.

In the example of FIG. 1, logic 111 may include logic 120, 130, and 135, all executable by computing circuitry 110, as described above. In other examples, logic 111 may include at least one of logic 120, 130, and 135, or a combination thereof. In FIG. 1, logic 111 is executable by computing circuitry 110 to receive a series of data 170 and an EOT message 160. In an example, the series of data 170 may comprise a series of writes. FIG. 1 illustrates the series of data 170 as a series of data blocks 170A-170D, for example, as described above. In the example of FIG. 1, logic 120 of computing circuitry 110 may receive the series of data 170 and the EOT message 160 from a sender 150. In an example, the sender 150 may be separate from the computing device 100. In another example, the sender 150 may comprise or be a part of a computing device that is similar to or the same as computing device 100, as described herein.

In FIG. 1, the computing circuitry 110 may comprise logic 130 executable to send an acknowledgment 180 to the sender 150 of the series of data 170 in response to determining whether the EOT message 160 indicates a request for acknowledgment 162 and upon full reception of the series of data 170 by computing circuitry 110. After logic 120 of computing circuitry 110 receives the EOT message 160, the logic 130 may determine whether the EOT message 160 indicates that the sender 150 requests an acknowledgment. In some examples, logic 130 may generate and send an acknowledgement 180 to an EOT message 160 when the EOT message 160 indicates a request for acknowledgement 162, and not otherwise. As noted above, the EOT message 160 may indicate a request for acknowledgment 162 through a predefined bit or bits in EOT message 160, or in any other suitable manner. In such examples, if appropriate bit(s) are set to indicate that acknowledgment is requested and the series of data 170 fully received, then the logic 130 may generate an acknowledgement 180 and send the acknowledgment 180 to the sender 150. In such examples, logic 130 providing acknowledgements 180 when requested (and not when they are not requested) may reduce the number of messages generated and sent by logic 130, which may improve the operating performance of computing circuitry 110 relative to examples in which acknowledgements 180 are always sent. In other examples, the logic 130 may provide an acknowledgment 180 for all incoming series of data (e.g., series of data 170). In such examples, logic 130 may generate and send a respective acknowledgement 180 in response to receiving an EOT message 160 associated with a series of data (received before the EOT message 160), regardless of whether the EOT message 160 indicates a request for acknowledgment. In such examples, logic 130 may send an acknowledgment 180 in response to reception of the EOT message 160, regardless of any other factor. Such examples may simplify the operation of computing circuitry 110.

In FIG. 1, logic 135 is executable by computing circuitry 110 to receive a request 182 to commit received data. In response to the request 182 to commit data, the logic 135 may append an interrupt 190 to the acknowledged series of data 170 (i.e., acknowledged to sender 150 by sending acknowledgment 180). After logic 135 appends the interrupt 190 to the series of data 170, logic 135 may initiate the commitment process. In an example, commitment to memory 192 is writing the acknowledged series of data 170 to a physical location in the memory 192. Logic 135 may write the acknowledged series of data 170 to memory 192. In an example, logic 135 may write the acknowledged series of data 170 in the sequential order in which the series of data 170 was received (e.g. logic 135 writes data block 170A, followed by data block 170B, and so on). After logic 135 commits the series of data 170 to memory 192, logic 135 may commit an interrupt 190 the processing resource 191.

In another example, the computing circuitry 110 may comprise logic executable to generate the request 182 to commit received data. In an example, the processing resource 191 may execute machine-readable instructions stored in a machine-readable storage medium. The executed machine-readable instructions may prompt the logic 111 of the computing circuitry 110 to generate the request 182 to commit. In another example, the executed machine-readable instructions may prompt the logic to generate the request 182 to commit data at any time. In another example, the computing circuitry 110 may comprise logic executable to determine that the sender 150 of the series of data 170 failed. In response to the senders 150 failure, the logic 111 may disable the logic 120 and then generate a request 182 to commit the data. In an example, when executing logic to disable logic 120, the computing device 100 may not receive data from a sender 150. In response to the request 182 to commit data, the computing circuitry 110 may process the request 182 to commit the data, as described above. The computing circuitry 110 may first send an acknowledgment 180 for the most recent series of data 170 received, up to the point that the request 182 to commit data is received. In an example, the computing circuitry 110 may not commit data received after the point in time the request 182 to commit data is received.

As described above, a series of data 170 is sent from a sender 150 and the computing device 100 receives the series of data 170. In an example, the sender 150 may send mirrored data. In another example, each series of data is sent in a sequential order. In another example, the series of data is a series of peripheral computer interconnect express (PCIe) transaction layer packets (TLPs). The sender 150 may break the data into the series of data (e.g. a series of PCIe TLPs).

As described above, the logic 135 may commit an interrupt 190 to memory 192. In an example, the logic 135 may select the interrupt 190 from an interrupt table based on the request 182 to commit data. The computing circuitry 110 may include the interrupt table. In another example, the interrupt 190 is a message system interrupt-x (MSI-X) and the interrupt table is a MSI-X vector table. In response to the request 182 to commit data, the logic 135 commits a specific interrupt 190 from the interrupt table, as described above.

In another example, the EOT message 160 may contain other parameters or data. In an example, the predefined bits in the EOT message 160 may include a pointer to a control block queue in the sender 150. The sender 150 may include the pointer of a current XOR control block that the sender 150 is processing. The XOR control block may point to the series of data 170 in the senders 150 memory. Upon receiving an acknowledgment 180, the sender 150 may store the pointer that the acknowledgment 180 returns. The sender 150 may continue to process XOR control blocks regardless of whether the sender 150 receives an acknowledgment 180. In response to a prompt, the sender 150 may transfer the stored pointer or pointers to the senders 150 memory. The pointer or pointers may indicate to the sender 150 that a series of sent data (as well as the data sent before that series of data) is acknowledged.

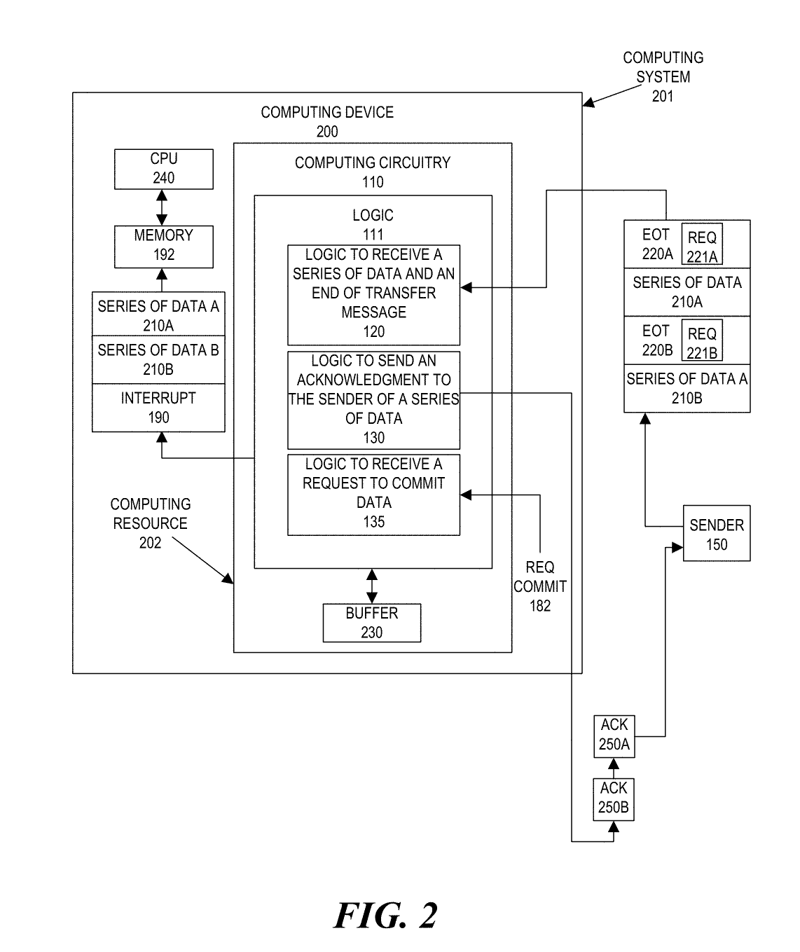

FIG. 2 is a block diagram of an example computing system 201 including computing circuitry 110 to acknowledge a series of data, receive a request 182 to commit data, and commit acknowledged data. FIG. 2 illustrates a computing system 201 that comprises a CPU 240, a memory 192 associated with the CPU 240, and a computing circuitry 110. FIG. 2 illustrates series of data 210A and series of data 2106. In other examples, more, fewer, or different series of data may be transferred from the sender. In an example, each series of data 210 is associated with an EOT message 220, the EOT message 220 following the series of data 210. In an example, each EOT message 220 may indicate a request for acknowledgment 221. In an example, when the computing device 200 receives a series of data 210, logic 120 may store the series of data 210 in a buffer 230. In response to a request to acknowledge 221 the series of data 210, logic 120 may send an acknowledgment after each series of data is received (e.g. acknowledgment 250A is sent upon reception of the series of data 210A and acknowledgment 250B is sent upon reception of the series of data 210B). The acknowledgment 250 does not indicate where in the computing device 200 the series of data 210 is located. The acknowledgment 250 indicates that the series of data 210 is located, at least, in the buffer 230. The series of data 210 may be located anywhere in the computing device 200 at the time the acknowledgment 180 is sent. The acknowledgment 180 indicates to the sender 150 that the series of data 210 is received by the computing circuitry 110. In response to a request to commit data 182, logic 135 transfers the series of data 210 from buffer 230, or wherever the series of data 210 is at that point in time, to the memory 192. Immediately following the series of data 210, an interrupt 190 is written to memory 192. The interrupt 190 indicates to the CPU 240 that the memory 192 contains the acknowledged series of data 210.

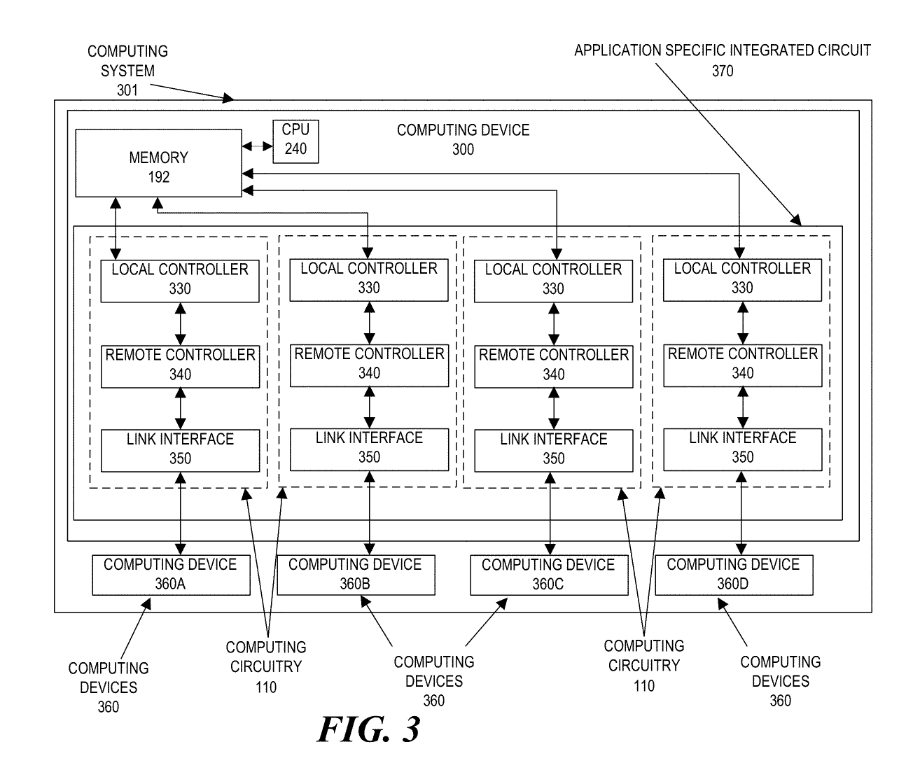

FIG. 3 is a block diagram of an example computing system with multiple instances of computing circuitry 110 to acknowledge and commit a series of data. FIG. 3 illustrates a computing system 301 that includes a computing device 300 communicating with other computing devices 360. In this example, the ASIC 370 includes multiple instances of the computing circuitry 110. Each computing circuitry 110 instance may be identical or similar to each other computing circuitry 110 instance. In an example, a link interface 350 and a remote controller 340 implement the logic 120 to receive a series of data and EOT message. The link interface 350 connects to other computing devices 360. In an example, five computing devices 300, 360 are included in the computing system 301. The computing system 301 may include more, fewer, or different computing devices 300, 360. While the connections to the computing device 300 are shown, each computing device 360, other than computing device 300, may couple to each other computing device 360. In another example, the computing devices 300, 360 may be tightly coupled nodes in a storage server cluster. Each node coupling to other nodes to create a mesh network. A computing device 360 may transfer a series of data and EOT message to computing device 300. The link interface 350 receives the series of data and EOT message. The link interface 350 transfers the series of data and EOT message to the remote controller 340. In one example, the link interface 350 is a PCIe connection and the series of data is a series of PCIe TLPs. The PCIe TLPs are sent in a sequential order and each series of PCIe TLPs include an EOT message.

In FIG. 3, the remote controller 340 implements the logic to send an acknowledgment to the sender (e.g. one of computing devices 360) of a series of data. In one example, the remote controller 340 may check a predefined bit or series of bits in the EOT message. In response to the predefined bit or bits being set, the remote controller 340 may generate an acknowledgment message when the series of data is fully received by the remote controller 340. In one example, the remote controller 340 may, once the acknowledgment is generated, copy the contents of the EOT message to the acknowledgment message. The sender (e.g. one of computing devices 360) may store the contents of the acknowledgement, the acknowledgment containing a copy of the data of the EOT message. In such examples, the EOT message may contain a pointer from the sender. In another example and in response to the acknowledgment, the sender (e.g. one of computing devices 360) may send the next series of data to the computing device 300. In another example, the sender (e.g. one of computing devices 360) may send the next series of data to the computing device 300 regardless of whether the sender receives acknowledgement. In another example, the remote controller 340 may determine that the series of data is fully received upon reception of the EOT message. The remote controller 340 then may send the acknowledgment to the sender (e.g. one of computing devices 360).

In FIG. 3, the remote controller 340 may also implement the logic to generate a request to commit data. In one example, a request to commit data is generated upon failure of another computing device 360. In another example, the remote controller 340 may generate the request to commit data on demand. In another example, the CPU 240 may execute machine-readable instructions stored in a machine-readable storage medium. In such examples, the executed machine-readable instructions may prompt the remote controller 340 to generate a request to commit data. In another example, the executed machine-readable instructions may set a bit in a register to indicate to the remote controller 340 to generate the request to commit data. In such examples, the computing circuitry 110 may include the register described above. The remote controller 340 may check the register and, in response to a bit or bits being set in the register, the remote controller 340 may generate a request to commit data. The remote controller 340 may append the interrupt request to the end of the most recently acknowledged and uncommitted series of data. The remote controller 340 may send all acknowledged (at the point in time the remote controller generates the request to commit data) and uncommitted series of data, with the appended interrupt request, to the local controller 330. In some examples, some data may be sent to the local controller 330 before the generation of a request to commit data. In another example, the remote controller 340 may clear the register (the register that is set by the executed machine-readable instructions, described above) after the series of data and interrupt request is sent to the local controller 330.

In FIG. 3, the local controller 330 may also implement the logic 135 to receive the request to commit data. As described above, the local controller 330 receives the acknowledged, and uncommitted, series of data and the interrupt request from the remote controller 340. In response to and based on the interrupt request, the local controller 330 may look up an interrupt in an interrupt table. The local controller 330 may include the interrupt table. The local controller 330 may append the interrupt to the series of data. The local controller 330 may write the series of data, with the appended interrupt, to memory 192, in the sequential order in which the computing device 300 receives the series of data.

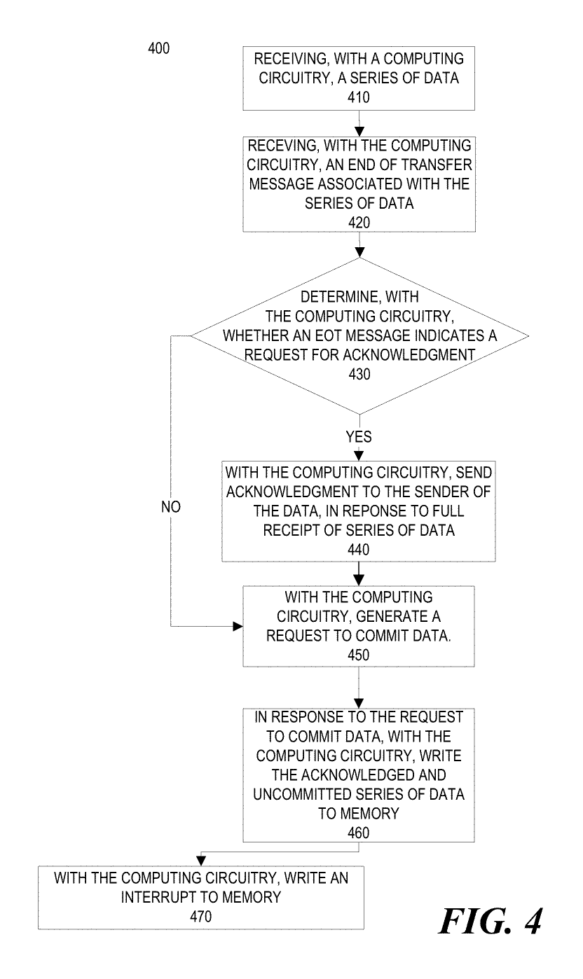

FIG. 4 is a flowchart of an example method 400 of a computing system including acknowledging and committing a series of data. Although execution of method 400 is described below with reference to computing system 101 of FIG. 1, other suitable systems for the execution of method 400 may be utilized (e.g., computing system 201 of FIG. 2). Additionally, implementation of method 400 is not limited to such examples.

In the example of FIG. 4, at 410 of method 400 computing circuitry 110 may receive a series of data 170 from a sender 150. In an example, the computing circuitry 110 may receive the series of data 170 in a sequential order. At 420, the computing circuitry 110 may receive an EOT message 190, the EOT message 190 associated with the series of data 170.

At block 430, the computing circuitry 110 may determine that the EOT message 190 indicates a request for acknowledgment 162. The EOT message 190 may indicate a request for acknowledgment 162 with a predefined bit or series of bits. While one series of data 170 is represented in FIG. 1, multiple series of data may be received, each series of data associated with an EOT message.

At block 440, in response to a determination that the EOT message 190 indicates a request for acknowledgment 162, the computing circuitry 110 sends an acknowledgment 180 to the sender 150 upon full reception of the series of data 170. The computing circuitry 110 may determine that the series of data 170 is fully received upon reception of the EOT message 190. In another example, the computing circuitry 110 may include a buffer and full reception of the series of data 170 may be indicated when the buffer receives the full series of data 170. In another example, the computing circuitry 110 may send an acknowledgment 180 regardless of whether the EOT message 190 indicates a request for acknowledgment 180.

At block 450, the computing circuitry 110 may generate a request to commit data. In an example, the computing circuitry 110 may generate the request to commit data upon failure of sender 150. In another example, the computing circuitry 110 may generate the request at any time. At block 460, in response to the generation of a request to commit data, the computing circuitry 110 may write the acknowledged series of data 170 to memory 192, the memory 192 associated with the processing resource 191 and the memory 192 and processing resource 191 separate from the computing circuitry 110. In an example, the computing circuitry 110 may write the acknowledged series of data 170 in the same sequential order in which the series of data was received 170.

At block 470, the computing circuitry 110 may write an interrupt 190 to the memory 192. In an example, the computing circuitry 110 may write the interrupt 190 to the memory 192 immediately following the computing circuitry 110 writing the acknowledged series of data 170 to the memory 192.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be examples. Structure and acts described herein are replaceable by equivalents, which perform the same function, even if the structure or acts are different, as known in the art. Therefore, the scope of the present disclosure is limited only by the elements and limitations as used in the claims

What is claimed is:

1. A computing resource comprising:
computing circuitry comprising logic executable to:
receive a series of data and an end of transfer (EOT) message associated with the series of data;
in response to a determination that the EOT message indicates a request for acknowledgement, send an acknowledgment to a sender of the series of data after receipt of all of the series of data at the computing circuitry is complete and before the series of data is committed to a memory associated with a processing resource, wherein the memory and the processing resource are separate from the computing circuitry; and
in response to a request to commit received data, commit the acknowledged and uncommitted series of data to the memory associated with the processing resource and interrupt the processing resource, the interrupt to indicate that the acknowledged series of data is committed to the memory associated with the processing resource.

2. The computing resource of claim 1, wherein the computing circuitry comprises logic executable to:
when the EOT message does not indicate a request for acknowledgment, send the acknowledgment to the sender of the series of data after receipt of all of the series of data at the computing circuitry is complete and before the series of data is committed to the memory associated with the processing resource.

3. The computing resource of claim 1, wherein the computing circuitry comprises logic executable to:
generate the request to commit received data.

4. The computing resource of claim 3, wherein the computing circuitry comprises logic executable to:
in response to failure of the sender of the series of data, disable reception of data from the sender of the series of data.

5. The computing resource of claim 4, wherein the computing circuitry comprises logic executable to:
in response to the failure of the sender of the series of data, generate the request to commit received data.

6. The computing resource of claim 1, wherein the computing circuitry comprises logic executable to:
receive the series of data in a sequential order; and
commit the series of data to the memory associated with the processing resource in the sequential order in which the series of data was received.

7. The computing resource of claim 1, wherein the computing circuitry comprises logic executable to:
in response to the request to commit received data, generate the interrupt based on an interrupt table, append the interrupt to the end of the acknowledged and uncommitted series of data, and commit the series of data and the interrupt to the memory associated with the processing resource.

8. The computing resource of claim 1, wherein the series of data is a series of peripheral component interconnect express (PCIe) transaction layer packets (TLPs).

9. The computing resource of claim 1, wherein the request for acknowledgment is indicated when a predefined request bit is set in the EOT message.

10. A system comprising:
memory associated with a processing resource;
computing circuitry to receive a series of data, receive an end of transfer (EOT) message associated with the series of data, and receive a request to commit data to the memory;
wherein, in response to a determination that the EOT message includes an acknowledgment request, upon full receipt of the series of data and the EOT message in a buffer of the computing circuitry, the computing circuitry is to generate and return an acknowledgment to the sender of the series of data; and
wherein, in response to the request to commit data to the memory, the computing circuitry is to transfer the acknowledged data to the memory in the order the acknowledged series of data was received, and, after the writing of the acknowledged series of data to the memory, the computing circuitry is to write an interrupt to the memory to indicate to the processing resource that the memory contains the acknowledged series of data.

11. The system of claim 10, wherein the computing circuitry is an application specific integrated circuit (ASIC).

12. The system of claim 10, wherein the computing circuitry is included in one of a set of computing circuits and the set of computing circuits is included in an ASIC.

13. The system of claim 10, wherein the processor, the memory, and the computing circuitry are included in a first computing device of a plurality of computing devices of the system.

14. The system of claim 13, wherein the series of data is received by the computing circuitry from a second computing device of the plurality of computing devices of the system.

15. The system of claim 10, wherein data included in the acknowledgment is a copy of the data contained in the EOT message.

16. A method comprising:
receiving, with computing circuitry of a computing device separate from a memory associated with a processing resource, a series of data and an end of transfer (EOT) message associated with the series of data;
determining, with the computing circuitry, whether the EOT message indicates a request for acknowledgment;
in response to a determination that acknowledgment is requested, with the computing circuitry, sending an acknowledgment to a sender of the series of data in response to full receipt of the series of data at the computing circuitry;
with the computing circuitry, generating a request to commit data; and
in a response to the request to commit data:
with the computing circuitry, writing the acknowledged series of data to the memory; and
in response to the acknowledged data being written to the memory, with the computing circuitry, writing an interrupt to the memory to indicate to the processing resource that the memory contains the acknowledged series of data.

17. The method of claim 16, further comprising:
with the computing circuitry, receiving the series of data in a sequential order; and
in response to the request to commit data, with the computing circuitry, writing the series of data to the memory in the sequential order.

18. The method of claim 16, wherein the generating the request to commit data is performed by the computing circuitry in response to a determination that the sender of the series of data has failed.

19. The method of claim 16, wherein the interrupt is defined in an interrupt table stored by the computing circuitry.

20. The method of claim 16, wherein full receipt of the series of data is indicated when the EOT message is received.
